(19) United States
(12) Patent Application Publication
(10) Pub. No.: US 2026/0120458 A1
(43) Pub. Date: Apr. 30, 2026

(54) SELF-SUPERVISED VISION TRANSFORMERS FOR AERIAL IMAGERY RECOGNITION

(71) Applicant: Allstate Insurance Company, Northbrook, IL (US)

(72) Inventors: Jeremy Werner, Northbrook, IL (US); Jean Utke, Northbrook, IL (US); Jingbo Liu, Northbrook, IL (US); Antonio Paiva, Northbrook, IL (US); Jordi Saperas, Northbrook, IL (US); Matt Miller, Northbrook, IL (US); James Mawhinney, Northbrook, IL (US); Sean Halvey, Northbrook, IL (US); Yang Liu, Northbrook, IL (US); Jenny Holzbauer, Northbrook, IL (US); Lakshmi Prabha Nattamai Sekar, Northbrook, IL (US); Rachel Carlin-Sharkey, Northbrook, IL (US); William Fewell, III, Northbrook, IL (US); Erin Franklin, Northbrook, IL (US); Merry Bradley, Northbrook, IL (US); Asmajabeen Syed Javad Hussain, Northbrook, IL (US); Andrew Dark, Northbrook, IL (US)

(73) Assignee: Allstate Insurance Company, Northbrook, IL (US)

(21) Appl. No.: 18/930,646

(22) Filed: Oct. 29, 2024

(51) Int. Cl. G06V 20/17; G06T 7/11; G06V 10/44

(52) U.S. Cl. CPC G06V 20/17; G06T 7/11; G06V 10/44

(57) ABSTRACT

A computing system comprises one or more processors and one or more storage devices that comprise instruction code that is executable by the one or more processors. The instruction code is executable by the processors to cause the computing system to receive an aerial image that depicts a property. Input embeddings associated with the aerial image are generated by a vision transformer. The vision transformer transforms the input embeddings to output embeddings that specify features of the aerial image. The vision transformer is trained using a self-supervised learning technique to generate the output embeddings. The ViT communicates the output embedding to a loss model. The loss model is trained to predict a loss score associated with the property depicted in the aerial image. An indication of the loss score associated with the property is output by the computing system.

### BACKGROUND

### I. Field

This application generally relates to the use of machine learning for performing image recognition tasks. In particular, this application relates to a system and method that uses self-supervised vision transformers to recognize aerial images.

### II. Description of Related Art

Convolutional Neural Networks (CNNs) have been the cornerstone of image classification tasks due to their ability to capture spatial hierarchies in images through convolutional layers, pooling layers, and fully connected layers. CNNs excel at extracting local features and building complex representations through their deep architectures, which have been instrumental in achieving state-of-the-art results in many computer vision applications. However, CNNs inherently focus on local receptive fields, which can limit their ability to capture long-range dependencies and global context in images. This makes them less effective in scenarios where understanding the entire image context is crucial. Additionally, CNNs require extensive manual design of architectures and can be sensitive to the choice of hyperparameters. Furthermore, supervised training techniques are customarily used to train CNNs. Such training techniques typically rely on large, labeled datasets for supervised learning, which can be labor-intensive and costly to obtain.

### SUMMARY

In a first aspect, a computing system comprises one or more processors, and one or more storage devices that comprise instruction code that is executable by the one or more processors. The instruction code is executable by the processors to cause the computing system to receive an aerial image that depicts a property. A vision transformer generates one or more input embeddings associated with the aerial image and transforms the one or more input embeddings to one or more output embeddings that specify features of the aerial image. The vision transformer is trained using a self-supervised learning technique to generate the one or more output embeddings that specify the features of the aerial image. At least one of the one or more output embeddings is communicated to a loss model. The loss model is trained to predict a loss score associated with the property depicted in the aerial image. An indication of the loss score associated with the property is output by the computing system.

In a second aspect, a non-transitory computer-readable medium has stored thereon instruction code that is executable by one or more processors of a computing system to cause the computing system to receive an aerial image that depicts a property. A vision transformer of the computing system generates one or more input embeddings associated with the aerial image and transforms the one or more input embeddings to one or more output embeddings that specify features of the aerial image. The vision transformer is trained using a self-supervised learning technique to generate one or more output embeddings that specify the features of the aerial image. At least one of the one or more output embeddings is communicated to a loss model. The loss model is trained to predict a loss score associated with the property depicted in the aerial image. An indication of the loss score associated with the property is output by the computing system.

In a third aspect, a computer-implemented method comprises receiving an aerial image that depicts a property. The method comprises generating, by a vision transformer, one or more input embeddings associated with the aerial image and transforming the one or more input embeddings to one or more output embeddings that specify features of the aerial image. The vision transformer is trained using a self-supervised learning technique to generate the one or more output embeddings that specify the features of the aerial image. The method comprises communicating at least one of the one or more output embeddings to a loss model. The loss model is trained to predict a loss score associated with the property depicted in the aerial image. The method further comprises outputting an indication of the loss score associated with the property.

### BRIEF DESCRIPTION OF THE DRAWINGS

The accompanying drawings are included to provide a further understanding of the claims, are incorporated in, and constitute a part of this specification. The detailed description and illustrated examples described serve to explain the principles defined by the claims.

FIG. 1 illustrates an environment that includes various systems/devices that facilitate assessing the amount of loss associated with a property based on an aerial image of the property, in accordance with example embodiments.

FIG. 2 illustrates components of an aerial image capture device (AICD), in accordance with example embodiments.

FIG. 3 illustrates an aerial imagery prediction loss system (AILPS), in accordance with example embodiments.

FIG. 4A illustrates loss prediction logic of the AILPS, in accordance with example embodiments.

FIG. 4B illustrates feature prediction logic of the AILPS, in accordance with example embodiments.

FIG. 5 illustrates operations for training a vision transformer of the loss prediction logic, in accordance with example embodiments.

FIG. 6 illustrates operations for training the loss model of the loss prediction logic, in accordance with example embodiments.

FIG. 7 illustrates operations that facilitate assessing/predicting loss associated with a property, in accordance with example embodiments.

FIG. 8 illustrates a computer system that can form part of or implement any of the systems and/or devices described above, in accordance with example embodiments.

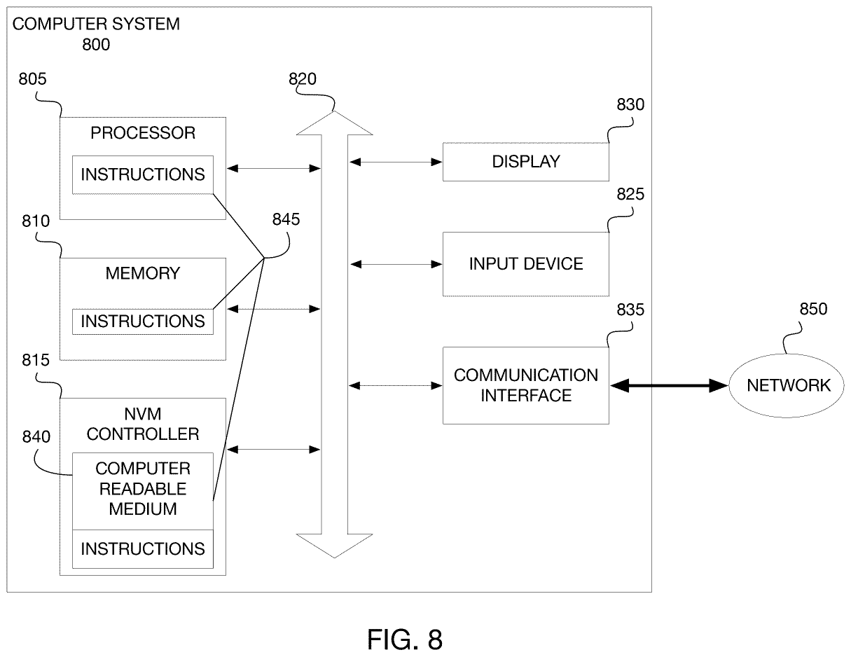

### DETAILED DESCRIPTION

Various examples of systems, devices, and/or methods are described herein. Any embodiment, implementation, and/or feature described herein as being an “example” is not necessarily to be construed as preferred or advantageous over any other embodiment, implementation, and/or feature unless stated as such. Thus, other embodiments, implementations, and/or features may be utilized, and other changes may be made without departing from the scope of the subject matter presented herein.

Accordingly, the examples described herein are not meant to be limiting. It will be readily understood that the aspects of the present disclosure, as generally described herein, and illustrated in the figures, can be arranged, substituted, combined, separated, and designed in a wide variety of different configurations.

Further, unless the context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Therefore, such enumeration should not be interpreted to require or imply that these elements, blocks, or steps adhere to a specific arrangement or are carried out in a specific order.

Further, terms such as “A coupled to B” or “A is mechanically coupled to B” do not require members A and B to be directly coupled to one another. It is understood that various intermediate members may be utilized to “couple” members A and B together.

Moreover, terms such as “substantially” or “about” that may be used herein mean that the recited characteristic, parameter, or value need not be achieved exactly. Deviations or variations, including tolerances, measurement error, measurement accuracy limitations, and other factors known to skill in the art, may occur in amounts that do not preclude the effect the characteristic was intended to provide.

### III. Introduction

Some insurance loss prediction systems utilize trained convolutional neural networks (CNNs) to assess loss based on aerial imagery of target properties such as homes, buildings, etc. Training of the CNNs involves collecting a large number of high-resolution aerial images of similar properties (e.g., images of homes and buildings of various shapes, sizes, materials, etc.) and labeling these images to indicate the features depicted in the images (e.g., providing labels indicating a particular roof shape, roof material, roof overhang, whether there is a pool on the property, etc.). The CNN architecture is then selected or customized, and the model is trained on the labeled dataset using supervised learning techniques. During training, the model learns to predict a particular feature based on the input images. For example, a first model may be trained to predict the roof shape of a roof depicted in an image, a second model may be trained to predict the roof material of the roof, a third model may be trained to predict the amount of the roof obstructed from view by trees, etc. Once trained, the CNN models may be used to predict these features on new aerial images. The predicted features may then be input to one or more subsequent models such as loss models that are trained using historical claims data to predict a loss score indicative of the amount of loss an insurance company might incur were there to be a claim for damage to the property depicted in the aerial image.

Disclosed herein are examples of aerial imagery loss prediction systems (AILPS) and methods performed by the systems that use vision transformers (ViTs) to predict loss based on aerial imagery. The ViTs leverage self-attention mechanisms that allow them to model relationships between all parts of an image, providing a more flexible and global understanding of the content depicted within the image. This ability to capture long-range dependencies and context has been shown to improve performance on tasks that benefit from a holistic view of the image, such as loss prediction. Moreover, ViTs can often handle a wide variety of image resolutions and sizes more naturally than CNNs due to their patch-based processing. In general, the system pre-processes raw aerial images of a property and then communicates the processed images to a ViT. The ViT generates one or more embeddings that capture the property information in a structured format. This structured embedding facilitates the creation of lightweight machine-learning models for various tasks, such as loss modeling and property attribute prediction. The vision transformer is trained using a custom self-supervised learning technique with millions of unlabeled aerial images to generate one or more output embeddings that specify the features of the images.

As noted above, some examples of the AILPS are configured to receive an aerial image that depicts a property. Some examples of the aerial image correspond to an overhead or bird's-eye view of the property, an oblique view of the property, etc., and the depicted property occupies substantially the entire frame of the image. For example, where the property is a house, the entire outline of the house may substantially occupy the entire frame of the image.

After receiving the aerial image, the AILPS inputs the images into the ViT. The ViT divides the aerial images into several respective patches (e.g., 16×16 patches). The patches are flattened into a one-dimensional vector and then linearly projected into a lower-dimensional space using a patch embedding layer. Position embeddings and a classification token (CLS) are appended to the linearly projected patch embeddings.

Next the ViT generates output embeddings that specify the features of the aerial image. The ViT is trained using self-supervised learning techniques. In some examples, the ViT is trained using a first dataset that comprises unlabeled aerial images depicting properties. In some examples, the first dataset comprises millions of images. As such, it may take significant processing power and time to train the ViT (e.g., several weeks). In some examples, a first subset of images in the first dataset corresponds to overhead views of properties, and a second subset of images in the first dataset corresponds to oblique views of properties. In some examples, images depicting overhead views and images depicting oblique views of the same property may be provided in the first dataset. In some examples, the self-supervised learning technique is a contrastive self-supervised learning technique. In some examples, the self-supervised learning technique used to train the ViT involves generating a second ViT instance, where the second ViT corresponds to a teacher ViT, and the first ViT corresponds to a student ViT. The teacher ViT is trained with the global views of an image, and the student ViT is trained with random local views of the same image. The student ViT is updated by learning from the teacher ViT in some generic classification tasks, and the teacher ViT is updated much less frequently compared to student ViT. After the training converges, the teacher ViT is the final model for the self-supervised training.

The AILPS communicates one or more of the output embeddings generated by the ViT to a loss model trained to predict a loss score associated with the output embeddings. In some examples, the loss score indicates the potential loss an insurance company could incur if there were a claim for damage to the property depicted in the aerial image. Some examples of the loss model implement linear regression. In this regard, in some examples, the loss model is trained using a second dataset of labeled images (e.g., images labeled with a loss score such as 0 or 500, corresponding to historical loss amounts.) In some instances, the second dataset is relatively small compared to the first dataset. For example, the second dataset may contain a few hundred labeled images. Consequently, the time and processing power needed to train the loss model may be significantly less than that required for the ViT (e.g., a few days).

Training the loss model involves converting the labeled images into embeddings using the ViT and then using the embeddings as training data for the loss model. The trainable parameters associated with the loss model are adjusted through several iterations until the loss model outputs scores that substantially match the score labels associated with the labeled images. The state of the ViT is maintained or frozen during the loss model training process.

As noted above, the ViT outputs several embeddings. In some examples, the ViT outputs a CLS embedding and a patch embedding associated with each patch of a particular aerial image. In some examples, the loss model is trained based on the CLS embedding, and in some other examples, the loss model is trained based on the patch embeddings. For example, when assessing the loss associated with damage to a feature that occupies several patches of the aerial image, such as the roof of a house, the CLS embedding may be used. When assessing the loss associated with damage to a feature that may only occupy a single patch (e.g., a pool on the property), patch embeddings may be used.

In some examples, the ViT can be used with different downstream models to facilitate performing different downstream tasks without requiring re-training. For example, a roof shape model may be trained using the same ViT and on aerial images labeled with roof shape information to predict the shape of a roof depicted in an aerial image. A roof material model may be trained using the same ViT and on aerial images labeled with roof material information to predict the roof material of a roof depicted in an aerial image. Other models may be trained using the same ViT to predict other aspects of the property depicted in images that are labeled accordingly.

### IV. Example Environment

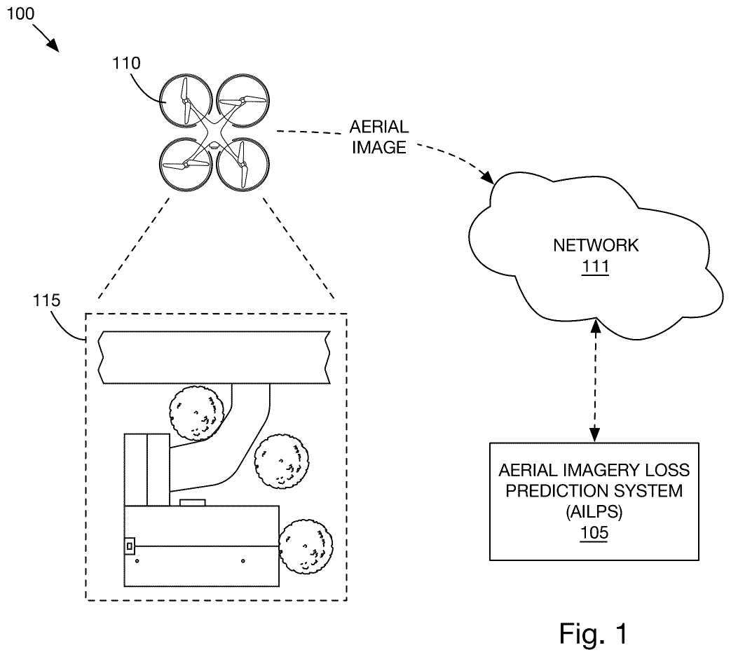

FIG. 1 illustrates an example of an environment 100 that includes various systems/devices that facilitate assessing the amount of loss associated with a property based on an aerial image 115 of the property. Example systems/devices of the environment 100 include an aerial imagery loss prediction loss system (AILPS) 105 and an aerial image capture device (AICD) 110. In some examples, the AILPS 105 and AICD 110 communicate information to one another via a communication network 111, such as the Internet, a cellular communication network, a Wi-Fi network, etc. In some examples, the AICD 110 may store or transmit the raw sensed images to an intermediate imaging system, which may perform a plurality of processing steps, such as color calibration, rotation, alignment, scaling, and/or mosaicking. Additionally, the images may be stored in a database. The AILPS (105) can retrieve the images centered around the property of interest via a communication network whenever necessary.

As described in further detail below, some examples of the AILPS 105 are configured to receive one or more aerial images 115 that depict a property and assess/predict an amount of loss associated with a property. Some examples of the loss correspond to insurance loss (e.g., the financial cost incurred by an insurance company when a policyholder makes a claim). This cost may include the amount paid to the policyholder to cover the damage or loss specified in the claim, as well as associated expenses such as claim processing, legal fees, and administrative costs.

In some examples, the AICD 110 corresponds to a drone that includes high-resolution cameras that facilitate the capture of aerial images of houses, buildings, etc., providing a comprehensive view of these structures from above. The drone may fly over a property and capture detailed photographs that encompass the entirety of a property, including the roof, yard, and surrounding landscape. In some examples, the AICD 110 may correspond to a satellite equipped with advanced optical sensors capable of high-resolution imaging that facilitates capturing images of houses and other structures. Some examples of the satellite orbit the Earth at various altitudes, with some in low Earth orbit (LEO) to provide detailed images with resolutions ranging from a few meters to sub-meter levels, allowing for clear and precise visualization of individual buildings and infrastructure.

In some examples, when a customer applies for an insurance policy on their property (e.g., house), the insurance company may dispatch an AICD 110 such as a drone to the property to obtain aerial images 115 of the property. The aerial images 115 may be communicated to the AILPS 105, and the AILPS 105 may provide a loss prediction associated with the property. The insurance company may base the cost for providing the insurance policy at least in part on the predicted loss.

### a. Aerial Image Capture Device

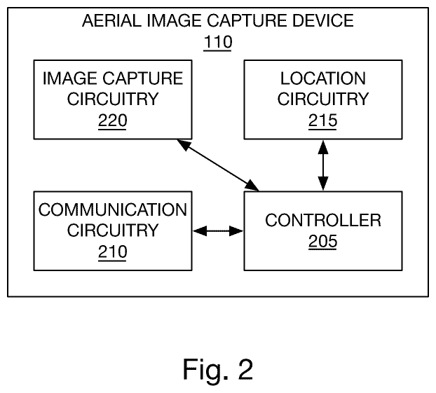

FIG. 2 illustrates example components of an aerial image capture device (AICD) 110. As shown in the figure, some examples of the AICD 110 include a controller 205, communication circuitry 210, location circuitry 215, and image capture circuitry 220.

Some examples of the controller 205 comprise a processor and a memory that is in communication with the processor. The processor is configured to execute instruction code stored in the memory. The instruction code facilitates performing, by the AICD 110, various operations that are described herein. In this regard, the instruction code may cause the processor to control and coordinate various activities performed by the different subsystems of the AICD 110. Some examples of the processor correspond to an ARM®, Intel®, AMD®, PowerPC®, etc., based processor. Some examples of instruction code stored in the memory and executed by the processor implement an operating system, such as Android™, IOS®, Windows®, Linux®, or a different operating system.

Some examples of the communication circuitry 210 comprise circuitry that facilitates wired and/or wireless communications with other devices or systems. An example of the wireless communication circuitry includes cellular telephone communication circuitry configured to communicate information over a cellular telephone network such as a 3G, 4G, and/or 5G network. Other examples of the wireless communication circuitry facilitate communication of information via an 802.11-based network, Bluetooth®, Zigbee®, near-field communication technology or a different wireless network.

Some examples of the location circuitry 215 correspond to global positioning system circuitry (GPS circuitry) configured to determine the geographic location of the AICD 110 based on signals received from a constellation of satellites. Some examples of the location circuitry 215 are configured to determine the location of the AICD 110 based on signals received from one or more cellular communication towers. Some examples of the location circuitry periodically (e.g., every second) determine the location (e.g., latitude and longitude) of the AICD 110. In this regard, in some examples, location data communicated by the AICD 110 includes latitude/longitude samples that specify the latitude/longitude of the AICD 110 and a timestamp that indicates a time at which the AICD 110 was at a particular location. In some examples, the location circuitry 215 outputs location data at a particular sample rate, such as 1 sample per second (i.e., at a 1 Hz sample rate).

Some examples of the image capture circuitry 220 correspond to an image sensor, such as a charge-coupled device (CCD), an active-pixel sensor, etc., for capturing pixels of information associated with an image. Some examples of the image capture circuitry 220 are configured to capture still images, video, etc. Some examples of the image capture circuitry 220 are configured to capture relatively high-resolution images (e.g., 2 k, 4 k, etc.). An example of the imager circuitry includes distance measurement circuitry (e.g., laser distance circuitry) that facilitates determining the distance between a subject and the image sensor.

In operation, the AICD 110 may be used, for example, by an insurance company to obtain aerial images 115 of a property. The aerial images 115 may be captured by the image capture circuitry 220 and communicated to the AILPS 105 using the communication circuitry 210. In some examples, the AICD 110 may store captured images in the internal storage of the AICD 110, such as on a secure digital (SD) card, and the stored captured images may be retrieved at a later time.

### b. Aerial Imagery Loss Prediction System

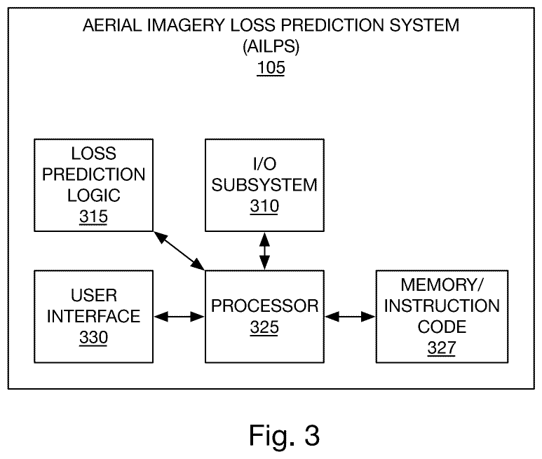

FIG. 3 illustrates an example of an aerial imagery prediction loss system (AILPS) 105. Referring to the figure, the AILPS 105 includes a memory 327, a processor 325, a user interface 330, an input/output (I/O) subsystem 310, and loss prediction logic 315.

The processor 325 is in communication with the memory 327 and is configured to execute instruction code stored in the memory 327. The instruction code facilitates performing, by the AILPS 105, various operations that are described herein. In this regard, some examples of the instruction code cause the processor 325 to control and coordinate various activities performed by the different subsystems of the AILPS 105. Some examples of the processor 325 correspond to a stand-alone computer system such as an ARM®, Intel®, AMD®, or PowerPC® based computer system or a different computer system and can include application-specific computer systems. Some examples of the computer system include an operating system. Examples of the operating system include Android™, Windows®, Linux®, Unix®, or a different operating system.

Some examples of the I/O subsystem 310 include one or more input/output interfaces configured to facilitate communications with entities outside of the AILPS 105. Some examples of the I/O subsystem 310 include wireless communication circuitry configured to facilitate communicating information to and from the AILPS 105. Examples of the wireless communication circuitry include cellular telephone communication circuitry configured to communicate information over a cellular telephone network such as a 3G, 4G, and/or 5G network. Other examples of the wireless communication circuitry facilitate the communication of information via a WiFi-based network, Bluetooth®, Zigbee®, near-field communication technology or a different wireless network.

Some examples of the I/O subsystem 310 are configured to communicate information via a RESTful API or a Web Service API. Some examples of I/O subsystem 310 implement a web server to facilitate generating one or more web-based interfaces through which users of the AILPS 105 and/or other systems interact with the AILPS 105.

### V. Example Loss Prediction Logic

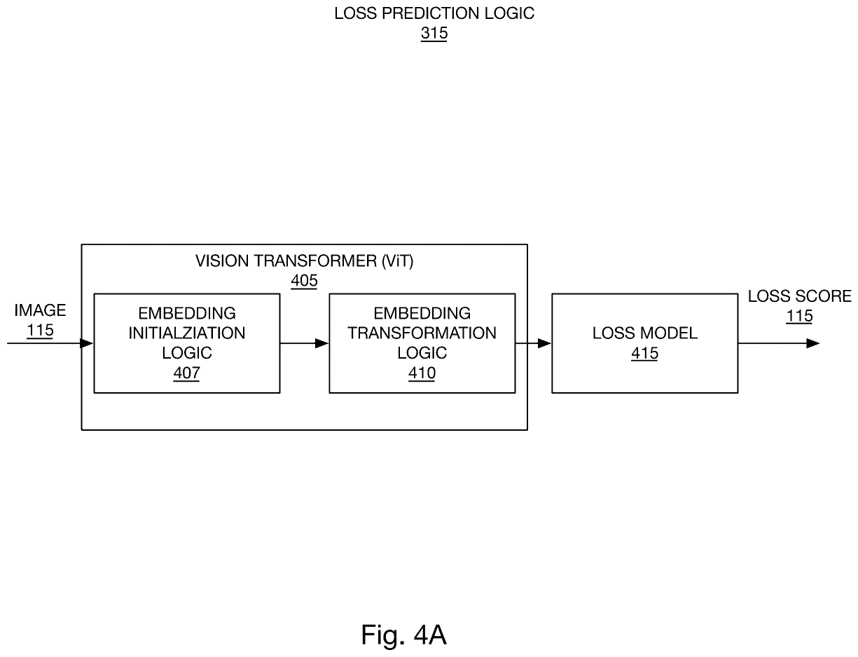

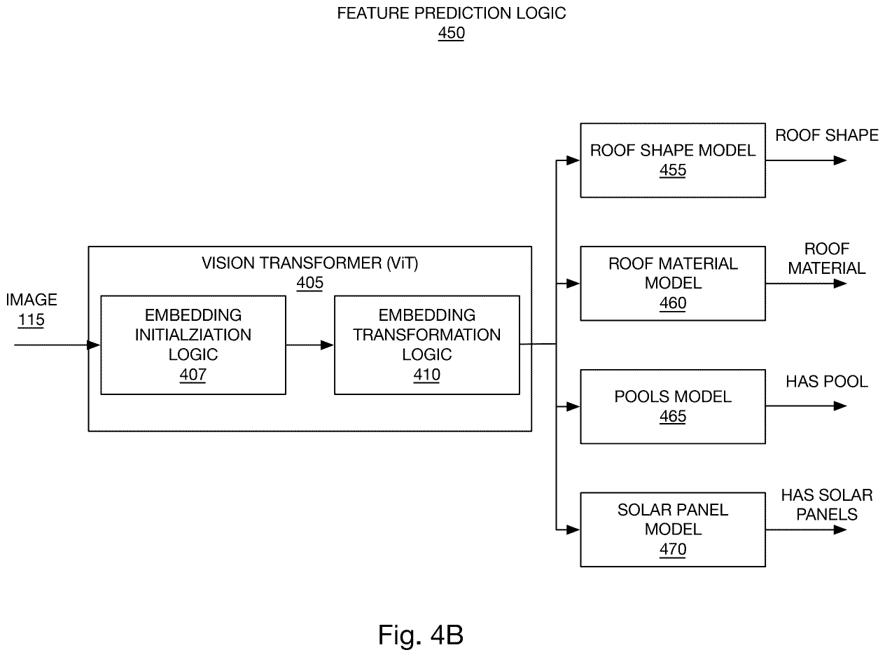

FIG. 4A illustrates an example of loss prediction logic 315. The loss prediction logic 315 includes a vision transformer (ViT) 405 and a loss model 415. Some examples of the ViT 405 include embedding initialization logic 407 and embedding transformation logic 410. As described in more detail below, the loss prediction logic 315 is configured to receive an aerial image 115 of a property and to generate a loss score 115 (e.g., 0-500) that is indicative of the amount of loss predicted to be incurred by an insurance company in servicing a claim associated with the property depicted in associated with an aerial image 115.

Some examples of the embedding initialization logic 407 are configured to perform operations for initializing the embeddings associated with an image 115. In some examples, the term “input embedding” is used to refer to an embedding that is in an initialized/non-transformed state. Some examples of the operations performed by the embedding initialization logic 407 involve dividing each image 115 into a grid of smaller, non-overlapping patches. For example, a 256×256 pixel image may be divided into 16×16 patches, resulting in 256 patches. Each patch is then flattened into a one-dimensional vector that corresponds to a patch embedding. For instance, a 16×16 patch from an image with 3 color channels (RGB) would be flattened into a vector of length 16×16×3=768. The flattened vectors are then linearly projected into a lower-dimensional space using a patch embedding layer. This transformation is akin to multiplying the flattened vector by a weight matrix and adding a bias term. The output of this projection is a vector of a fixed size, sometimes referred to as the embedding dimension D. Mathematically, if xᵢ is the flattened vector of the iₜₕ patch, and W is the weight matrix for the linear layer, the embedded vector zᵢ is computed as: zᵢ=Wxᵢ+b, where W is a learnable matrix of shape (D, patch ¿¿ and b is a bias vector of shape (D). Because transformers are permutation-invariant, they lack the inductive bias of convolutional layers that capture spatial hierarchies. To provide the model with information about the position of each patch, position embeddings are added to the linearly projected patch embeddings. These position embeddings are learnable vectors that are added to each patch embedding, ensuring that the model can incorporate spatial information about where each patch is located in the original image. A classification token denoted as CLS is prepended to the sequence of patch embeddings before the embeddings are transformed. The CLS token is a learnable embedding vector that is designed to aggregate information from the entire input sequence during the self-attention process. The combined patch embeddings, positional embeddings, and CLS embedding are subsequently transformed by the embedding transformation logic 410. The overall length of the embedding is based on the overall architecture of the ViT 405, including the number of layers and the design of the attention mechanism. In the ViT-Small implementations, the overall architecture of the ViT 405 results in an embedding length of 384.

Some examples of the embedding transformation logic 410 are configured to process the input embeddings through multiple layers of multi-head self-attention. In each self-attention layer, the model computes the attention scores between all pairs of embeddings, allowing it to weigh the importance of each patch relative to every other patch and CLS token. This helps the model capture relationships and dependencies across the entire image. After the self-attention layer, the embeddings are passed through a feed-forward network (FFN). Some examples of this network comprise two linear layers with a non-linear activation function such as Gaussian Error Linear Unit (GELU) in between. The FFN refines the embeddings by applying learned transformations. Each self-attention and feed-forward block is accompanied by layer normalization and residual connections. These components help stabilize training and improve the flow of gradients. The processing of embeddings by the multiple layers of the ViT 405, transforms the input embeddings (e.g., patch embeddings and CLS token embedding) into output embeddings. The output embeddings associated with an image 115 contain rich, contextual information about the image patches, influenced by their relationships with other patches. The output embedding corresponding to this CLS token, in particular, aggregates information from all patches and serves as a summary representation of the entire image.

Some examples of the loss model 415 implement linear regression. The model works by fitting a linear relationship to the feature space defined by one or more embeddings and mapping the features to target labels of downstream tasks.

Some examples of the loss model 415 are trained using logistic regression. This technique involves estimating the probability that a given input belongs to a particular class using the logistic function. In some examples, this involves optimizing the model's weights through techniques such as gradient descent to minimize a loss function such as categorical cross-entropy for multi-class classification. In some examples, the loss model 415 uses linear discriminant analysis (LDA), which assumes normally distributed classes and aims to find a linear combination of features that best separates the classes. LDA involves calculating the means and variances of each class and then computing a linear decision boundary based on these statistics. Other techniques may be used to train the loss model 415.

In some examples, the loss model 415 is trained based on the CLS embedding and in some other examples, the loss model 415 is trained based on the patch embeddings. For example, when assessing the loss associated with damage to a feature that occupies several patches of the aerial image 115, such as the roof of a house, the CLS embedding may be used. When assessing the loss associated with damage to a feature that may only occupy a single patch (e.g., a pool on the property), the patch embeddings may be used.

### VI. Example Feature Prediction Logic

FIG. 4B illustrates an example of feature prediction logic 450 that may be implemented by some examples of the AILPS 105. The feature prediction logic 450 includes a vision transformer (ViT) 405, a roof shape model 455, a roof material model 460, a pools model 465, and a solar panel model 470. The roof shape model 455 and the roof material model 460 are trained to predict the roof shape and roof material, respectively, associated with an aerial image 115. The pools model 465 and the solar panel model 470 are trained to predict, respectively, whether the depicted property includes a pool or a solar panel. The models above are merely examples. Other models for predicting can be developed according to the techniques described herein to facilitate predicting other features of the aerial image 115.

Certain aspects performed by the feature prediction logic 450 are similar to aspects performed by the loss prediction logic 315. For example, the vision transformer (ViT) 405 is configured to convert aerial images 115 to an input embedding. The ViT 405 is trained to generate output embeddings that specify features of the aerial image 115 based on the input embeddings. In some examples, the ViT 405 may be shared between the feature prediction logic 450 and the loss prediction logic 315. The output embeddings generated by the ViT 405 are input to the roof shape model 455, roof material model 460, pools model 465, and solar panel model 470.

Like the loss model 415 described above in regard to FIG. 4A, the roof shape model 455, roof material model 460, pools model 465, and solar panel model 470 may each implement and be trained using linear regression. Some examples of the models may be trained based on the CLS embeddings output by the ViT 405 and some other examples of the models may be trained based on the patch embeddings. For instance, training of the roof shape model 455 may be based on aerial images 115 that specify/label information indicative of the roof shape, and training of the roof material model 460 may be based on aerial images 115 that specify/label information indicative of the roof material. Inputting the CLS embeddings of the ViT 405, rather than patch embeddings, to the roof shape model 455 and the roof material model 460 may yield more accurate downstream predictions because the roof may occupy a significant portion (i.e., many patches) of the labeled aerial images 115. Training of the pools model 465 may be based on aerial images 115 that specify/label whether a property has a pool, and training of the solar panel model 470 may be based on aerial images 115 that specify/label whether a property has a solar panel. Inputting the patch embeddings of the ViT 405, rather than the CLS embedding, to the pools model 465 and the solar panel model 470 because the pool and solar panel features may only occupy a single patch.

### VII. Example Operations

### a. Vit Training

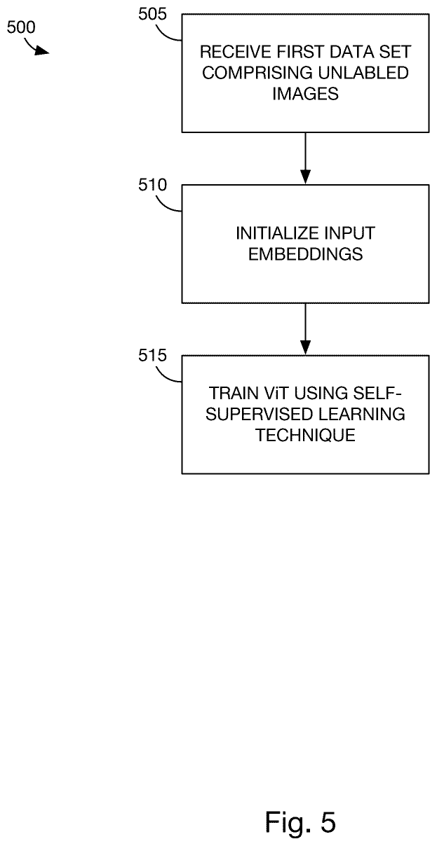

FIG. 5 illustrates examples of operations for training the ViT 405 of the loss prediction logic 315. In some examples, the ViT 405 is trained using self-supervised learning techniques. For example, the ViT 405 is trained using a first dataset that comprises unlabeled images. In some examples, one or more of these operations are implemented via instruction code, stored in corresponding data storage (e.g., memory 327) of these systems. Execution of the instruction code by corresponding processors of the systems causes these systems to perform these operations alone or in combination with other systems and/or devices.

The operations at block 505 involve receiving a first dataset comprising images. In some examples, the first dataset comprises a relatively large number of unlabeled images (e.g., 10 M images). In some examples, the images correspond to aerial images depicting properties (e.g., homes, buildings, etc.) Some examples of the images in the first dataset capture overhead/bird's eye views of the properties. Some examples of the images in the first data set capture oblique views of the properties such as aerial images of a property captured by the AICD 110 when it is not directly over the property. In this regard, in some examples, some of the images correspond to video frames captured by the AICD 110 as the AICD 110 passes over a particular geographic region.

In some examples, each image of the first dataset is associated with a single property, and the entirety of the particular property is depicted within the frame of the image. For example, the bounds of the corresponding property (e.g., the property line) fit within the image frame. In some examples, one or more of the images in the first dataset are derived from one or more different images that capture larger areas. For example, a high-resolution satellite image depicting a particular geographic area (e.g., a city and its surrounding suburbs) may be partitioned into smaller images, each depicting a particular property. In some examples, partitioning involves using preexisting property line data to identify image sections associated with different properties.

The operations at block 510 involve generating the input embeddings (i.e., initializing the embeddings that will subsequently be transformed to output embeddings). In some examples, this involves the embedding initialization logic 407 dividing each image into a grid of smaller, non-overlapping patches. For example, a 256×256 pixel image may be divided into 16×16 patches, resulting in 256 patches. Each patch is then flattened into a one-dimensional vector that corresponds to a patch embedding. For instance, a 16×16 patch from an image with 3 color channels (RGB) would be flattened into a vector of length 16×16×3=768. The flattened vectors are then linearly projected into a lower-dimensional space using a patch embedding layer. Position embeddings and a classification token (CLS) are appended to the linearly projected patch embeddings and together correspond to the input embedding that is subsequently processed by the embedding transformation logic 410.

The operations at block 515 involve using a self-supervised learning technique to train the ViT 405. In some examples, the self-supervised learning technique involves using a second ViT (teacher network) to train or teach the first ViT 405 (the student network). The teacher network is trained in a self-supervised manner and learns to capture the underlying structure and patterns in the data to learn more robust and general features and to produce meaningful representations (i.e., pseudo-labels) of the input data without needing explicit labels. The student network learns from the pseudo-labels generated by the teacher network. After the student network is trained, the teacher network may be discarded. In some examples, a self-supervised learning technique such as a modified version of the self-supervised learning technique disclosed by Caron, Mathilde, et al. in “Emerging Properties in Self-Supervised Vision Transformers.” Proceedings of the International Conference on Computer Vision (ICCV), 2021, is used to train the ViT 405.

In some examples, the instruction code that implements the operations described above for training the ViT 405 is executed on specialized hardware to reduce training time. For instance, in some examples, the instruction code is executed on a supercomputing system that includes several graphics processing units (GPUs) that facilitate parallel computing operations such as one or more Cray Cluster supercomputing systems. For instance, in some examples, the first dataset is divided into smaller batches, and each batch is processed in parallel on a different GPU of the supercomputing system, where each GPU holds a replica of the model. After each forward and backward pass through the model, gradients computed on each GPU are averaged (or summed) across all GPUs to synchronize the GPUs.

Other techniques can be used to further reduce training time. For example, in some examples, the attention algorithm (e.g., flash attention) is optimized to speed up training and save GPU memory. In some examples, a gradient accumulation algorithm with an optimized training schedule that increases the effective batch size and training stability is used. In some examples, an image augmentation algorithm is executed on a GPU. In some examples, types if imags, such as large photos related to an insurance claims, may put a significant I/O constraints on the iterative model training. In some examples, this issue is mitigated by providing a cache strategy is designed to solve this bottleneck by caching the intermediate smaller images on disk and reuse for future iterations in the training.

In some examples, the operations described above for training the ViT are performed on the AILPS 105. In some other examples, the operations for training the ViT are performed by a different system and ViT model data that defines the trained ViT 405 is communicated to the AILPS 105. After receiving the ViT model data, the AILPS 105 instantiates a ViT 405 based on the ViT model data. In this regard, in some examples, the trained ViT 405 serves as a foundational model that can be used by many other systems that implement downstream tasks for classifying aerial images, outputting textual representations of aerial images, generating aerial images based on one or more queries, etc.

### B. Loss Model Training

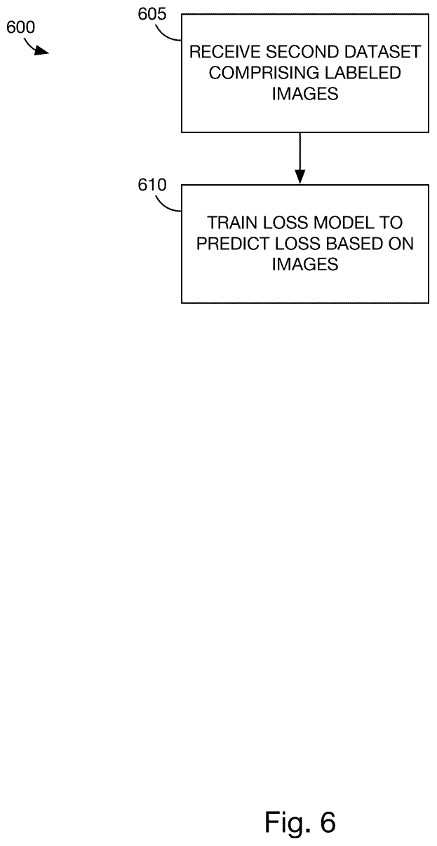

FIG. 6 illustrates examples of operations for training the loss model 415 of the loss prediction logic 315. In some examples, one or more of these operations are implemented via instruction code, stored in corresponding data storage (e.g., memory 327) of these systems. Execution of the instruction code by corresponding processors of the systems causes these systems to perform these operations alone or in combination with other systems and/or devices.

The operations at block 605 involve receiving a second dataset comprising images. In some examples, the second dataset comprises a relatively small number of labeled images (e.g., several hundred images). In some examples, the images correspond to aerial images depicting properties (e.g., homes, buildings, etc.) Some examples of the images in the second dataset capture oblique views of the properties such as aerial images of a property captured by the AICD 110 when it is not directly over the property. In this regard, in some examples, some of the images correspond to video frames captured by the AICD 110 as the AICD 110 passes over a particular geographic region.

In some examples, each image of the first dataset is associated with a particular property and the entirety of the particular property is depicted within the frame of the image. For example, the bounds of the corresponding property (e.g., the property line) fit within the image frame. In some examples, one or more of the images in the first dataset are derived from one or more different images that capture larger areas. For example, a high-resolution satellite image depicting a particular geographic area (e.g., a city and its surrounding suburbs) may be partitioned into smaller images, each depicting a particular property. In some examples, partitioning involves using preexisting property line data to identify image sections associated with different properties.

As noted above, each image is also associated with a label. In some examples, the label corresponds to a loss score (e.g., 0-500) that is indicative of the amount of loss incurred by an insurance company in servicing a claim associated with the property. For example, a loss score of zero may indicate that there was no loss or cost associated with the claim. A loss of 10 may indicate that the cost associated with the claim was $100,000. In some examples, the loss score may correspond to an actual dollar amount such as $0, $1000, $10,000, $100,000, etc.

The operations at 610 involve training the loss model 415 to predict loss based on the images of the second dataset. In this regard, in some examples, the loss model 415 is trained by iteratively adjusting trainable parameters of the neural network implemented by the loss model 415 (e.g., via backpropagation and forward propagation techniques) until the output nodes of the neural network make the correct prediction regarding the training data. That is, the trainable parameters of the neural network are adjusted so that when a particular image that is associated with a particular loss score is input into the loss model 415, the loss model 415 outputs the corresponding loss score. In some examples, the trainable parameters of the nodes of the ViT 405 are frozen/not updated while the loss model 415 is trained. This, in turn, vastly reduces the number of interactions and time needed to train the loss model. In some examples, trainable parameters of the nodes of some sections of the ViT 405 may be updated to an extent to fine-tune the ViT 405 to facilitate more accurate prediction.

### c. Inference

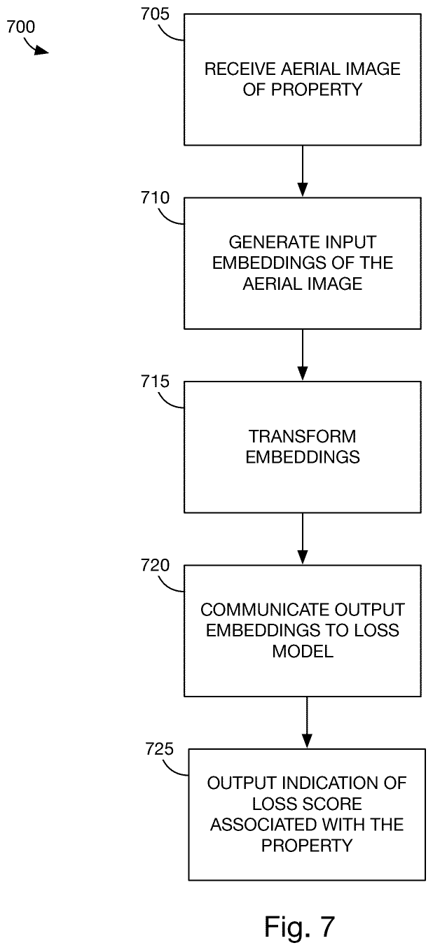

FIG. 7 illustrates examples of operations 700 that may be performed by some systems described above to facilitate assessing/predicting loss associated with a property. These operations are performed by some examples of the systems described above (e.g., the AILPS 105, the AICD 110, etc.). In some examples, one or more of these operations are implemented via instruction code, stored in corresponding data storage (e.g., memory 327) of these systems. Execution of the instruction code by corresponding processors of the systems causes these systems to perform these operations alone or in combination with other systems and/or devices.

The operations at block 705 involve the AILPS 105 receiving an aerial image 115 of a property. In some examples, the aerial image 115 is captured by the AICD 110. In some examples, the aerial image 115 is communicated directly from the AICD 110 to the AILPS 105 via a network 111. In some examples, the AILPS 105 may generate a web interface configured to allow uploading of the aerial image 115 (e.g., by an appraiser for an insurance company).

In some examples, the aerial image 115 depicts a structure such as a home, building, etc. In some examples, the image is a birds-eye view of the property. In some examples, the image captures an oblique view of the property such as an aerial image 115 of the property captured by the AICD 110 when the AICD 110 is not directly over the property. In this regard, in some examples, some of the images correspond to video frames captured by the AICD 110 as the AICD 110 passes over a particular geographic region.

In some examples, the aerial image 115 is associated with a single property, and the entirety of the property is depicted within the frame of the aerial image 115. For example, the bounds of the corresponding property (e.g., the property line) fit within the image frame. In some examples, the aerial image 115 may be derived from one or more different images that capture larger areas. For example, a high-resolution satellite image depicting a particular geographic area (e.g., a city and its surrounding suburbs) may be partitioned into smaller images, each depicting a particular property. In some examples, partitioning involves using preexisting property line data to identify image sections associated with different properties and dividing the images that depict the larger areas along the property lines specified in the property line data.

The operations at block 710 involve the embedding initialization logic 407 of the ViT 405 generating an input embedding of the aerial image 115. In some examples, this involves dividing the aerial image 115 into a grid of smaller, non-overlapping patches. For example, a 256×256 pixel image may be divided into 16×16 patches, resulting in 256 patches. Each patch is then flattened into a one-dimensional vector that corresponds to a patch embedding. For instance, a 16×16 patch from an image with 3 color channels (RGB) would be flattened into a vector of length 16×16×3=768. The flattened vectors are then linearly projected into a lower-dimensional space using a patch embedding layer. Position embeddings and a classification token (CLS) are appended to the linearly projected patch embeddings and together correspond to the input embedding.

The operations at block 715 involve the embedding transformation logic 410 of the ViT 405 transforming the input embedding to an output embedding. In some examples, this involves processing the embeddings through multiple layers of multi-head self-attention. In each self-attention layer, the model computes the attention scores between all pairs of embeddings, allowing it to weigh the importance of each patch relative to every other patch. This helps the model capture relationships and dependencies across the entire image. After the self-attention layer, the embeddings are passed through a feed-forward network (FFN). Some examples of this network comprise two linear layers with a non-linear activation function such as Gaussian Error Linear Unit (GELU) in between. The FFN refines the embeddings by applying learned transformations. Each self-attention and feed-forward block is accompanied by layer normalization and residual connections. These components help stabilize training and improve the flow of gradients. After passing through the multiple layers of the ViT 405, the embeddings are transformed into output embeddings. These output embeddings contain rich, contextual information about the image patches, influenced by their relationships with other patches. The output embedding corresponding to this CLS token is used for the final classification task. This token aggregates information from all patches and serves as a summary representation of the entire image.

The operations at block 720 involve the AILPS 105 communicating one or more output embeddings generated by the ViT 405 to a loss model. Some examples of the loss model 415 implement linear regression. The model works by fitting a linear relationship to the feature space defined by the CLS embedding and mapping the features to target labels of downstream tasks.

In some examples, the CLS embedding of the output embeddings is communicated to the loss model 415. The CLS embedding aggregates information from all patches and serves as a summary representation of the entire image. The CLS embedding may be communicated to the loss model 415 to facilitate classifying features of the property that are expected to span multiple patches such as the rooftop of a structure.

In some examples, the patch embeddings of the output embeddings are communicated to the loss model 415. The patch embeddings may be communicated to the loss model 415 to facilitate classifying loss associated with features of the property that are expected to mostly fall within a particular patch such as a pool.

The operations at block 725 involve outputting an indication of the loss score associated with the property depicted in the aerial image 115. For example, the AILPS 105 may communicate an indication of the loss score to an insurance system configured to generate an insurance policy, to an appraiser via a web interface generated by the AILPS 105, etc.

In some examples, the CLS embedding and/or the patch embeddings of the output embeddings may be communicated to other models, such as the roof shape model 466, roof material model 460, pools model 465, and solar panel model 470 described above in regard to FIG. 4B. These models facilitate predicting, respectively, the roof shape, the roof material, whether there is a pool on the property, and whether there is a solar panel on the property. For example, the CLS embedding of the ViT 405 may be input to the roof shape model 455 and the roof material model 460 because the roof may occupy a significant portion of the labeled aerial images 115. The patch embeddings of the ViT 405 may be input to the pools model 465 and the solar panel model 470 because the pool and solar panel features may only occupy single patches.

### VIII. Example Computer Systems

FIG. 9 illustrates an example of a computer system 900 that can form part of or implement any of the systems and/or devices described above. The computer system 900 can include a set of instructions 945 that the processor 905 can execute to cause the computer system 900 to perform any of the operations described above. An example of the computer system 900 can operate as a stand-alone device or can be connected, e.g., using a network, to other computer systems or peripheral devices.

In a networked example, the computer system 900 can operate in the charge capacity of a server or as a client computer in a server-client network environment, or as a peer computer system in a peer-to-peer (or distributed) environment. The computer system 900 can also be implemented or incorporated into various devices, such as a personal computer or a mobile device, capable of executing instructions 945 (sequential or otherwise), causing a device to perform one or more actions. Further, each of the systems described can include a collection of subsystems that individually or jointly execute a set, or multiple sets, of instructions to perform one or more computer operations.

The computer system 900 can include one or more memory devices 910 communicatively coupled to a bus 920 for communicating information. In addition, code operable to cause the computer system to perform operations described above can be stored in the memory 910. The memory 910 can be random-access memory, read-only memory, programmable memory, or any other type of memory or storage device.

The computer system 900 can include a display 930, such as a liquid crystal display (LCD), organic light-emitting diode (OLED) display, or any other display suitable for conveying information. The display 930 can act as an interface for the user to see processing results produced by processor 905.

Additionally, the computer system 900 can include an input device 925, such as a keyboard or mouse or touchscreen, configured to allow a user to interact with components of system 900.

The computer system 900 can also include a non-volatile memory (NVM) controller 915. The NVM controller 915 can include a computer-readable medium 940 (e.g., flash drive) in which the instructions 945 can be stored. The instructions 945 can reside completely, or at least partially, within the memory 910 and/or within the processor 905 during execution by the computer system 900. The memory 910 and the processor 905 also can include computer-readable media, as discussed above.

The computer system 900 can include a communication interface 935 to support communications via a network 950. The network 950 can include wired networks, wireless networks, or combinations thereof. The communication interface 935 can enable communications via any number of wireless broadband communication standards.

Accordingly, methods and systems described herein can be realized in hardware, software, or a combination of hardware and software. The methods and systems can be realized in a centralized fashion in at least one computer system or in a distributed fashion where different elements are spread across interconnected computer systems. Any kind of computer system or other apparatus adapted for carrying out the methods described herein can be employed.

The methods and systems described herein can also be embedded in a computer program product, which includes all the features enabling the implementation of the operations described herein and which, when loaded in a computer system, can carry out these operations. Computer program as used herein refers to an expression, in a machine-executable language, code or notation, of a set of machine-executable instructions intended to cause a device to perform a particular function, either directly or after one or more of a) conversion of a first language, code, or notation to another language, code, or notation; and b) reproduction of a first language, code, or notation.

While the systems and methods of operation have been described with reference to certain examples, it will be understood by those skilled in the art that various changes can be made and equivalents can be substituted without departing from the scope of the claims.

Therefore, it is intended that the present methods and systems not be limited to the particular examples disclosed, but that the disclosed methods and systems include all embodiments falling within the scope of the appended claims.

What is claimed is:

1. A computing system comprising:
one or more processors; and
one or more storage devices that comprise instruction code that is executable by the one or more processors to cause the computing system to:
receive an aerial image that depicts a property;
generate, by a vision transformer, one or more input embeddings associated with the aerial image;
transform, by the vision transformer, the one or more input embeddings to one or more output embeddings that specify features of the aerial image, wherein the vision transformer is trained using a self-supervised learning technique to generate the one or more output embeddings that specify the features of the aerial image; and
communicate at least one of the one or more output embeddings to a loss model, wherein the loss model is trained to predict a loss score associated with the property depicted in the aerial image; and
output an indication of the loss score associated with the property.

2. The computing system according to claim 1, wherein the instruction code that causes the computing system to generate the one or more input embeddings is executable to cause the computing system to:
divide the aerial image into a plurality of non-overlapping patches; and
generate one or more input embeddings that comprises the plurality of non-overlapping patches, positional embeddings, and a classification token.

3. The computing system according to claim 1, wherein the vision transformer is trained using a first dataset that comprises unlabeled aerial images depicting properties.

4. The computing system according to claim 3, wherein a first subset of the first dataset comprises one or more images that depict overhead views of properties and a second subset of the first dataset comprises one or more images that depict oblique views of the properties.

5. The computing system according to claim 1, wherein the vision transformer corresponds to a first vision transformer, wherein training the first vision transformer comprises:
generating a second vision transformer; and
using the second vision transformer to train the first vision transformer.

6. The computing system according to claim 1, wherein the loss model is trained using a second dataset that comprises labeled aerial images depicting properties.

7. The computing system according to claim 6, wherein labels associated with the labeled aerial images of the second dataset comprise an indication of a loss score associated with respective properties depicted in the aerial images.

8. The computing system according to claim 1, wherein the aerial image depicts an entirety of the property within a frame of the aerial image.

9. A non-transitory computer-readable medium having stored thereon instruction code that, when executed by one or more processors of a computing system, causes the computing system to:
receive an aerial image that depicts a property;
generate, by a vision transformer of the computing system, an one or more input embeddings associated with the aerial image;
transform, by the vision transformer, the one or more input embeddings to one or more output embeddings that specify features of the aerial image, wherein the vision transformer is trained using a self-supervised learning technique to generate the one or more output embeddings that specify the features of the aerial image;
communicate at least one of the one or more output embeddings to a loss model, wherein the loss model is trained to predict a loss score associated with the property depicted in the aerial image; and
output an indication of the loss score associated with the property.

10. The non-transitory computer-readable medium according to claim 9, wherein the instruction code that causes the computing system to generate the one or more input embeddings is executable to cause the computing system to:
divide the aerial image into a plurality of non-overlapping patches; and
generate one or more input embeddings that comprises the plurality of non-overlapping patches, positional embeddings, and a classification token.

11. The non-transitory computer-readable medium according to claim 9, wherein the vision transformer is trained using a first dataset that comprises unlabeled aerial images depicting properties.

12. The non-transitory computer-readable medium according to claim 11, wherein a first subset of the first dataset comprises one or more images that depict overhead views of properties and a second subset of the first dataset comprises one or more images that depict oblique views of the properties.

13. The non-transitory computer-readable medium according to claim 9, wherein the vision transformer corresponds to a first vision transformer, wherein training the first vision transformer comprises:
generating a second vision transformer; and
using the second vision transformer to train the first vision transformer.

14. The non-transitory computer-readable medium according to claim 9, wherein the loss model is trained using a second dataset that comprises labeled aerial images depicting properties.

15. The non-transitory computer-readable medium according to claim 14, wherein labels associated with the labeled aerial images of the second dataset comprise an indication of a loss score associated with respective structures depicted in the aerial images.

16. The non-transitory computer-readable medium according to claim 9, wherein the aerial image depicts an entirety of the property within a frame of the aerial image.

17. A computing-implemented method comprising:
receiving an aerial image that depicts a property;
generating, by a vision transformer, one or more input embeddings associated with the aerial image;
transform, by the vision transformer, the one or more input embeddings to one or more output embeddings that specify features of the aerial image, wherein the vision transformer is trained using a self-supervised learning technique to generate the one or more output embeddings that specify the features of the aerial image;
communicating at least one of the one or more output embeddings to a loss model, wherein the loss model is trained to predict a loss score associated with the property depicted in the aerial image; and
outputting an indication of the loss score associated with the property.

18. The computing-implemented method according to claim 17, wherein generating the one or more input embeddings further comprises:
dividing the aerial image into a plurality of non-overlapping patches; and
generating one or more input embeddings that comprises the plurality of non-overlapping patches, positional embeddings, and a classification token.

19. The computing-implemented method according to claim 17, wherein the vision transformer is trained using a first dataset that comprises unlabeled aerial images depicting properties.

20. The computing-implemented method according to claim 17, wherein the loss model is trained using a second dataset that comprises labeled aerial images depicting properties.
